(19) United States
(12) Patent Application Publication
(10) Pub. No.: US 2005/0174705 A1
(43) Pub. Date: Aug. 11, 2005

(54) Method for preventing cross-conductions and interactions between supply lines of a device and a circuit for limiting the voltage difference between two regulated output voltages

(75) Inventors: Davide Brambilla, Rho (IT); Daniela Nebuloni, Bareggio (IT)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics S.r.l., Agrate Brianza (IT)

(21) Appl. No.: 11/056,407

(22) Filed: Feb. 11, 2005

(30) Foreign Application Priority Data
Feb. 11, 2004 (EP) 04425088.4

(51) Int. Cl. H02H 7/00

(52) U.S. Cl. 361/18

(57) ABSTRACT

In a device that includes a pair of closed-loop voltage regulators each including an input transconductance stage receiving a reference voltage and a feedback voltage, an intermediate transresistance stage, an output buffer operatively in cascade for generating on an output node the regulated output voltage and negative feedback means for providing the feedback voltage to the input stage, the method includes a circuit that limits the difference between two output regulated voltages. The limiting circuit includes a differential transconductance amplifier input with voltages proportional to the output voltages of the regulators or obtained by adding an offset voltage to the output voltage of the regulators for injecting in, or draining from, an input node of the intermediate stage of one of the regulators, a current as a function of the relative unbalance of the differential transconductance amplifier.

### FIELD OF THE INVENTION

The present invention relates to voltage regulators, and, in particular, to a method for preventing cross-conductions between supply lines of a device powered at two different regulated voltages and a circuit for limiting the voltage difference between two regulated voltages generated by a pair of closed-loop voltage regulators.

### BACKGROUND OF THE INVENTION

Many modern electronic circuits are powered at two different supply voltages, such as microprocessors, which are generally supplied at 5V and 3.3V voltages, generated by respective voltage regulators that output a stable voltage independently from the load. The presence of two regulated power supplies is mandatory when in a same integrated device there are circuits that operate at different voltages or a sub-circuit that may be powered at a reduced voltage when in a stand-by condition for reducing overall power consumption of the device. The same situation may present itself, though temporarily, in other devices, where there is the need of starting-up softly certain sub-circuits by powering them at a reduced voltage and eventually at the nominal supply voltage.

Sometimes integrated circuits powered at two different supply voltages may unduly enter into a permanent latch condition from which they may exit only if restarted, and this often results in a loss of data. The cause of these malfunctions has not yet been adequately explained. Investigations of these phenomena have indicated that they are strongly correlated with sudden drops of the voltage level on one of the two distinct supply voltage lines of the device, for example, due to an accidental short-circuit. In such an event, certain supply lines of the device are grounded while other supply lines remain at their nominal voltage. Sometimes, a similar situation may occur at power-up if one of the two voltage regulators promptly reaches its nominal output voltage, while the other is still outputting an almost null voltage.

### SUMMARY OF THE INVENTION

It has been theorized that these conditions may cause cross-correlation effects between supply lines of the device and that these cross-correlations make the device enter into a permanent latched condition. According to this hypothesis, an approach to this problem has been devised. It includes reducing or preventing cross-conductions between supply lines of a device powered at two different supply voltages generated by respective voltage regulators, by limiting the difference between the voltages generated by the voltage regulators that supply the device. In doing so, if the output voltage of a regulator becomes null because of a fault, the output voltage of the other regulator that is functioning correctly is automatically reduced. Similarly, at the power up of the device-the voltage regulators are obliged to reach their nominal voltage almost simultaneously.

The invention may be usefully implemented in any integrated device that is powered at two different supply voltages generated by respective voltage regulators by a dedicated circuit that effectively limits the difference between the regulated supply voltages that are distributed to the operational circuitry of the device. In a very common case, the device includes a pair of closed-loop voltage regulators each comprising an input transconductance stage receiving a reference voltage and a feedback voltage, an intermediate transresistance stage, an output buffer operatively in cascade for generating on an output node the regulated output voltage and negative feedback means or path for providing the feedback voltage to the input stage.

The method of this invention may be implemented by a circuit that limits the difference between two output regulated voltages. The limiting circuit comprises at least a differential transconductance amplifier input with voltages proportional to the output voltages of the regulators or obtained by adding an offset voltage to the output voltage of the regulators for injecting in, or draining from, an input node of the intermediate stage of one of the regulators, a current in function of the relative unbalance of the differential transconductance amplifier.

### BRIEF DESCRIPTION OF THE DRAWINGS

The different aspects and advantages of this invention will become clearer through a detailed description referring to the attached drawings, wherein:

FIG. 1 is a timing diagram showing the desired turn-on and turn-off characteristics of two voltage generators of an integrated circuit;

FIG. 2 is a schematic diagram illustrating how the limiting circuit of this invention is coupled to the voltage regulators of a device;

FIG. 3 is a general diagram of a closed-loop voltage regulator;

FIG. 4 is a schematic diagram illustrating an embodiment of the limiting circuit of this invention coupled to two closed-loop voltage regulators;

FIGS. 5 to 7 are timing diagrams showing output characteristics of the regulators provided with the limiting circuit of this invention as in FIG. 4;

FIG. 8 is a schematic diagram illustrating an alternative embodiment to that of FIG. 4 of coupling the limiting circuit of this invention to two closed-loop voltage regulators;

FIG. 9 to 11 are timing diagrams showing output characteristics of the regulators provided with the limiting circuit of this invention as in FIG. 8; and

FIG. 12 shows another embodiment of the limiting circuit of this invention for two closed-loop voltage regulators.

### DETAILED DESCRIPTION OF THE PREFERRED EMBODIMENTS

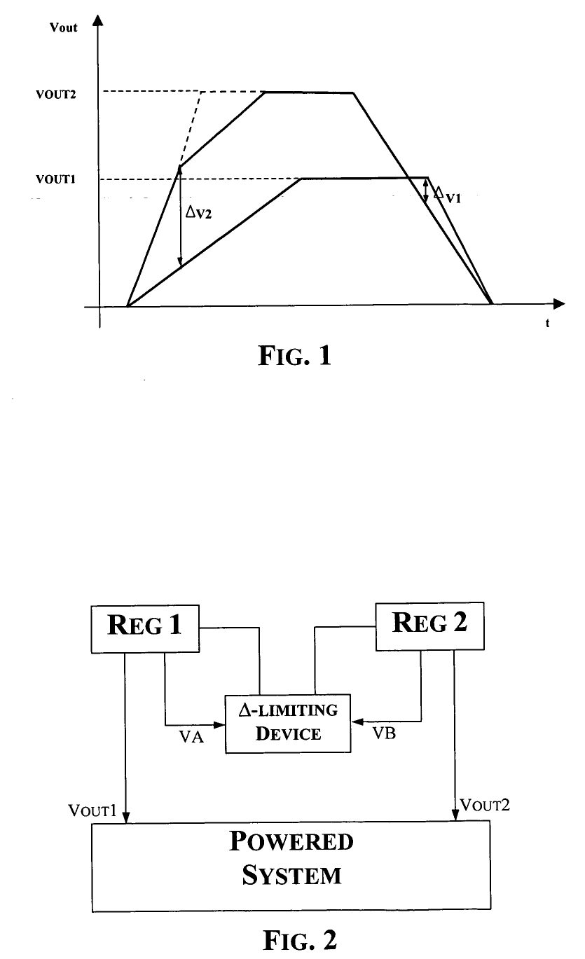

According to the invention, two regulated supply voltages VOUT1 and VOUT2 of an integrated device powered at two different voltages should be correlated as schematically shown in FIG. 1 to prevent cross-conduction effects between supply lines that may occasionally cause permanent latch conditions. When both voltage regulators are powered-up, it may happen that one of them tends to reach its nominal voltage VOUT2 quicker than the other. In this case it is desirable to diminish the slope of the output voltage ramp of the fastest voltage regulator (VOUT2), as depicted in FIG. 1, to limit the voltage difference ΔV2 between the two regulated voltages. The same must be done for limiting the voltage difference ΔV1 whenever one of the two regulated voltages suddenly decreases because an accidental short-circuit or any other cause. As an alternative, which is even easier to implement, one of the voltages (VOUT1) may be obliged to track the other voltage (VOUT2) to zero, as shown in FIG. 1.

A basic interconnection scheme of a circuit for limiting such a voltage difference Δ-LIMITING DEVICE and a pair of voltage regulators REG1 and REG2 supplying a functional circuit POWERED SYSTEM is depicted in FIG. 2. According to this invention a limiting circuit to be integrated with the voltage regulators of the device is input with voltages VA and VB proportional to the regulated supply voltages VOUT1 and VOUT2, respectively, or obtained by adding an offset voltage to the regulated supply voltages, and generates feedback signals appropriate for correcting one or the other of the two different supply voltages output by the respective regulators whenever their difference surpasses a certain value.

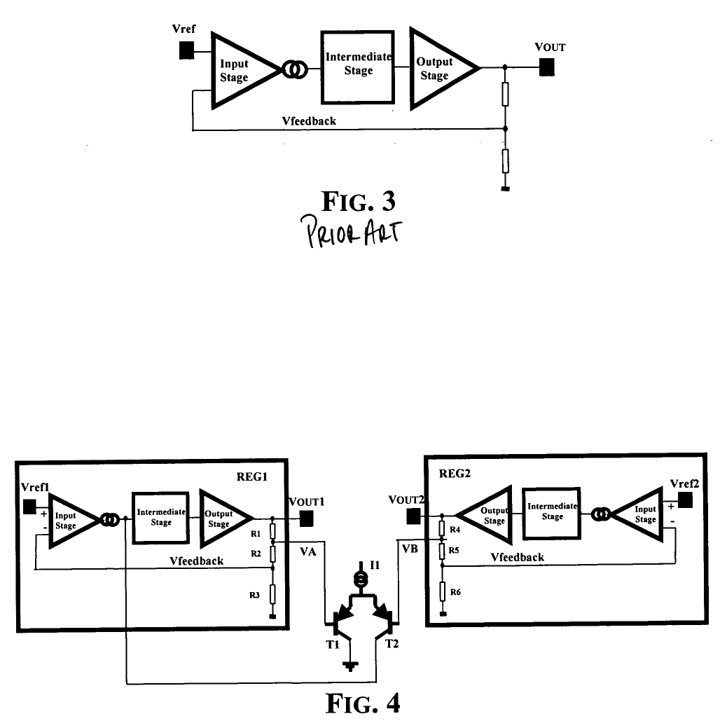

To better illustrate how an effective limiting circuit of this invention may be realized, reference will be made to the presence in the device of closed-loop voltage regulators, such as the one depicted in FIG. 3. Closed-loop regulators are very commonly used for powering integrated devices because they generate an output voltage which is practically independent from the load. In general, a closed-loop regulator includes an input transconductance stage INPUT_STAGE receiving a reference voltage VREF and a feedback voltage VFEEDBACK, an intermediate transresistance stage INTERMEDIATE_STAGE in cascade to the input stage and an output voltage buffer stage OUTPUT_STAGE that outputs the regulated voltage that is distributed to the supplied functional circuitry.

Preferably the limiting circuit of this invention is a transconductance amplifier, input with voltages VA and VB proportional to the regulated output voltages VOUT1 and VOUT2, respectively, of the regulators or obtained by adding an offset voltage to these regulated output voltages, that injects in or drains from an input node of the intermediate stage of at least one of the two regulators a certain current I1 as a function of the unbalance of the differential transconductance amplifier. In a simple and effective embodiment of the limiting circuit of this invention, the transconductance amplifier includes a differential pair of transistors connected to the closed-loop voltage regulators as depicted in FIG. 4. The voltage output by the intermediate transresistance stage depends on its input current, therefore the limiting circuit of this invention varies the output voltages VOUT1 and VOUT2 simply by injecting in or draining from the input node of the intermediate transresistance stage a certain current.

In the embodiment shown, the voltages VA and VB are generated by respective voltage dividers R1, R2, R3 and R4, R5, R6, respectively, and control the transistors T1 and T2 of the differential pair. If VB is larger than VA, the bias current I1 flows through the transistor T1 and the two voltage regulators work independently one from the other. By contrast, if VA exceeds VB, the current I1 flows through the transistor T2 and is injected in or drained from the input node of the transresistance stage INTERMEDIATE_STAGE. Therefore, the limiting circuit forces through this stage an additional current or makes it to be input with an almost null current, and consequently the output voltage VOUT1 varies for making the two voltages VA and VB equal to each other.

For example, if when the output voltage VOUT2 diminishes because of a transitory fault of the regulator REG2, the voltage VB decreases until it equals the voltage VA and a portion of the bias current I1 is injected on the input node of the intermediate stage and the voltage VOUT1 becomes null, as shown in FIG. 5. To nullify the current input to the intermediate stage, and thus to nullify the output voltage VOUT1, it is desirable to choose a bias current I1 equal to or even larger than the maximum current that may be output by the input stage.

Similarly, it is possible to control the transistor T1 with the voltage VB and the transistor T2 with the voltage VA or to use a transistor pair of opposite polarity for limiting the voltage difference when the two regulators are turned on and the output voltage VOUT2 tends to reach its nominal level faster than the voltage VOUT1, as shown in FIG. 1. When the difference ΔV2 between the two regulated voltages reaches a certain level, the voltage VB equals the voltage VA. In this situation, part of the bias current I1 of the differential pair is injected in the transresistance stage and the slope of the output voltage VOUT1 becomes steeper.

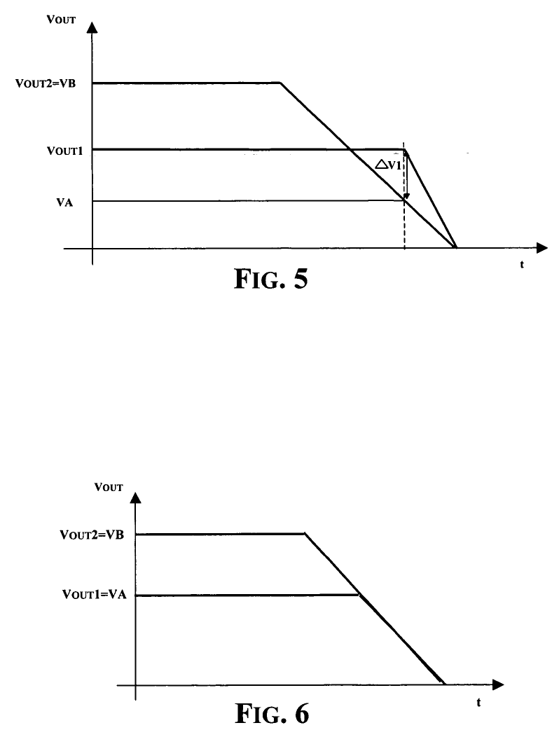

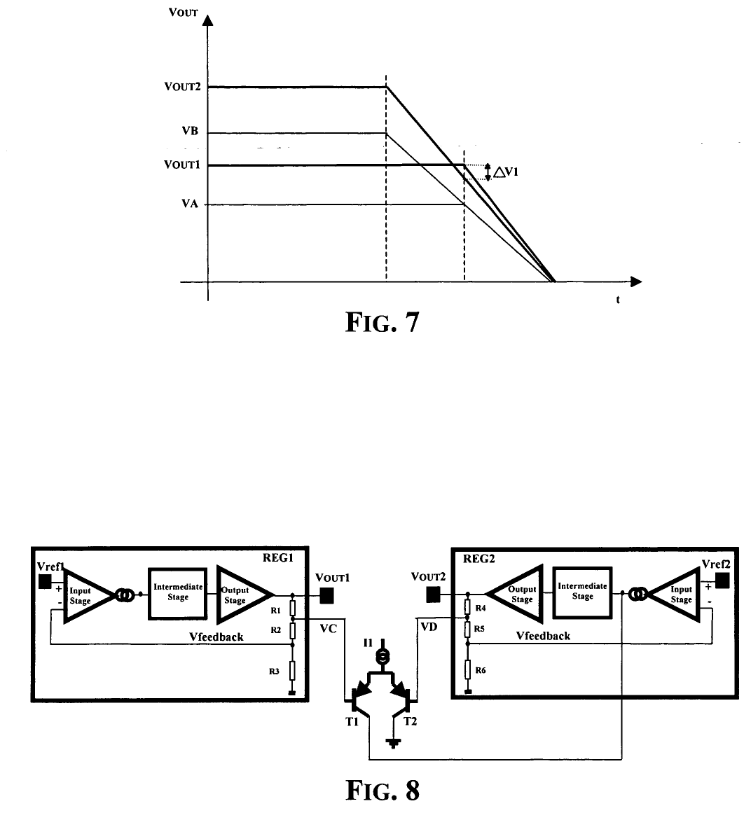

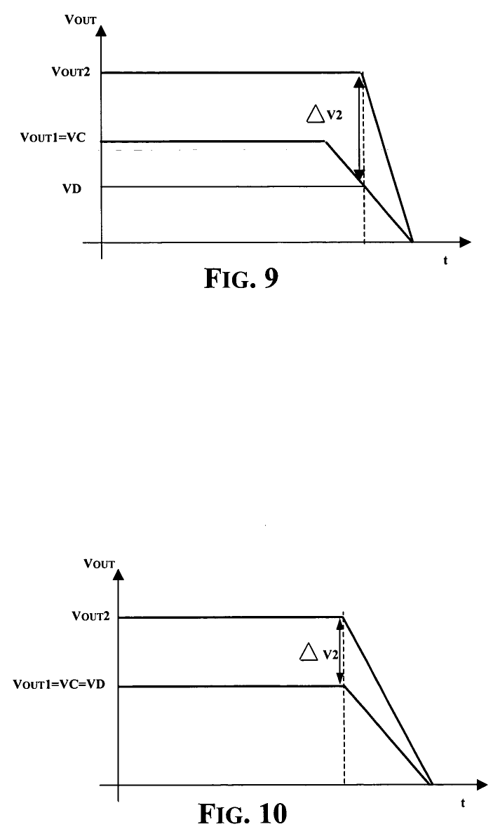

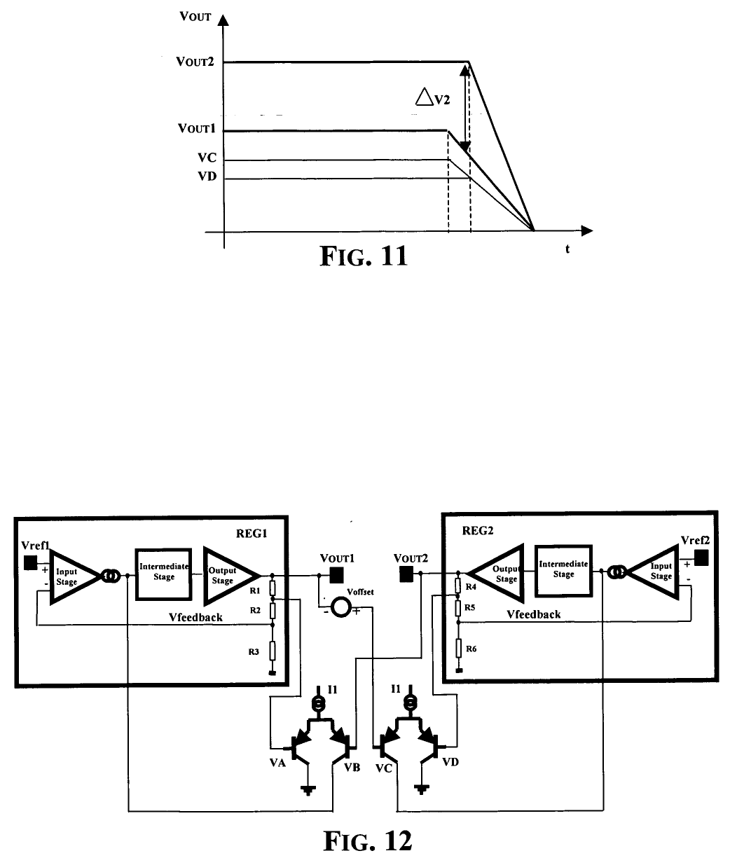

The maximum admissible voltage difference ΔV1 is fixed by the resistances R1, R2, R3, R4, R5, and R6 of the voltage dividers that generate the voltages VA and VB. The timing diagram of FIG. 5 has been obtained using a null resistance R4 and a non-null resistance R1, the timing diagram of FIG. 6 has been obtained for R1=R4=0 and the timing diagram of FIG. 7 has been obtained by choosing non null resistances R1 and R4. It is possible to connect the limiting circuit as shown in FIG. 8. In this configuration, the timing diagrams of FIGS. 9, 10 and 11 are obtained for: R1=0 and R4≠0; R1=0 and 1+R4/(R5+R6)=VOUT1/VOUT2; and R1≠0 and R4≠0, respectively. These timing diagrams will be understood by a skilled person in the art and do not require a detailed discussion thereof.

Of course, the limiting circuit may be realized even with two differential pairs of transistors by connecting them as shown in FIG. 12, for limiting both voltage differences ΔV1 and ΔV2. As shown in FIG. 12, at least one of the transistors of the limiting circuit may be controlled by a voltage obtained by adding an offset voltage VOFFSET to the voltage output by a regulator.

The differential pairs may be MOS transistors instead of bipolar junction transistors (BJT) as shown in the figures. As an alternative, the BJTs depicted in FIGS. 4, 8 and 12 may be replaced with BJTs of opposite polarity with the grounded output nodes of the differential pairs of transistors connected to a positive supply voltage, as will be understood to those skilled in the art.

1-8. (canceled)

9. A method of preventing cross-conductions between supply lines of a device powered at two different regulated supply voltages generated by respective voltage regulators, comprising:
operating the voltage regulations; and
limiting a voltage difference between the regulated supply voltages.

10. The method of claim 9, wherein each voltage regulator comprises a closed-loop voltage regulator including an input transconductance stage receiving a reference voltage and a feedback voltage, an intermediate transresistance stage, an output buffer for generating the regulated output voltage on an output node, and a feedback circuit for providing the feedback voltage to the input transconductance stage; and wherein limiting comprises:
limiting the voltage difference between the regulated output voltages by at least one of injecting in and drawing from an input node of the intermediate stage of one of the voltage regulators, a current based upon the voltage difference.

11. The method of claim 10, wherein limiting further comprises:
generating first and second voltages proportional to the output voltage of one of the voltage regulators; and
at least one of injecting in and drawing from the input node of the intermediate stage of one of the voltage regulators a current based upon the voltage difference between the first and second proportional voltages.

12. The method of claim 10, wherein limiting further comprises:
generating first and second voltages by adding respective offset voltages to the output voltage of one of the voltage regulators; and
at least one of injecting in and drawing from the input node of the intermediate stage of one of the voltage regulators a current based upon the voltage difference between the first and second voltages.

13. A method of regulating power in an integrated circuit device, comprising:
powering the integrated circuit device at two different regulated supply voltages; and
reducing cross-conductions between supply lines of the integrated circuit device by limiting a voltage difference between the regulated supply voltages.

14. The method of claim 13, wherein powering the integrated circuit device comprises providing each of the regulated supply voltages with a respective closed-loop voltage regulator including an input stage receiving a reference voltage and a feedback voltage, an intermediate stage, an output buffer for generating the regulated output voltage on an output node, and a feedback circuit for providing the feedback voltage to the input stage; and wherein reducing cross-conductions comprises limiting the voltage difference between the regulated output voltages by at least one of injecting in and drawing from an input of the intermediate stage of one of the closed-loop voltage regulators, a current based upon the voltage difference.

15. The method of claim 14, wherein limiting further comprises:
generating first and second voltages proportional to the output voltage of one of the voltage regulators; and
at least one of injecting in and drawing from the input node of the intermediate stage of one of the voltage regulators a current based upon the voltage difference between the first and second proportional voltages.

16. The method of claim 14, wherein limiting further comprises:
generating first and second voltages by adding respective offset voltages to the output voltage of one of the voltage regulators; and
at least one of injecting in and drawing from the input node of the intermediate stage of one of the voltage regulators a current based upon the voltage difference between the first and second voltages.

17. An integrated device comprising:
an electronic circuit;
respective voltage regulators to generate a plurality of different regulated supply voltages to power the electronic circuit; and
a limiting circuit for limiting a voltage difference between the regulated supply voltages.

18. The device of claim 17 wherein each of the voltage regulators comprises a closed-loop voltage regulator comprising an input stage to receive a reference voltage and a feedback voltage, an intermediate stage, an output buffer to generate on an output the regulated output voltage, and a feedback circuit to provide the feedback voltage to the input stage; and wherein the limiting circuit comprises at least one differential transconductance amplifier input with voltages proportional to the output voltages of the regulators, to at least one of inject in or drain from an input of the intermediate stage of one of the regulators an output current based upon an output of the differential transconductance amplifier.

19. The device of claim 17 wherein each of the voltage regulators comprises a closed-loop voltage regulator comprising an input stage to receive a reference voltage and a feedback voltage, an intermediate stage, an output buffer to generate on an output the regulated output voltage, and a feedback circuit to provide the feedback voltage to the input stage; and wherein the limiting circuit comprises at least one differential transconductance amplifier input with voltages obtained by adding an offset voltage to the output voltage of the regulators, to at least one of inject in or drain from an input of the intermediate stage of one of the regulators an output current based upon an output of the differential transconductance amplifier.

20. The device of claim 18, wherein the differential transconductance amplifier comprises:
a differential pair of transistors controlled by the respective proportional voltages; and
a current generator to bias the differential pair of transistors with a current larger than a maximum differential current input to the intermediate stage of the regulator.

21. The device of claim 20, wherein the limiting circuit comprises a pair of transconductance amplifiers, each input with a respective proportional voltage.

22. The device of claim 21, wherein at least one of the amplifiers recieves a comparison voltage obtained by adding an offset voltage to the output voltage of the regulator.

23. The device of claim 21, wherein the amplifiers each recieve a respective comparison voltage obtained by adding a respective offset voltage to the output voltage of the respective regulator.
